(19) United States
(12) Patent Application Publication
(10) Pub. No.: US 2011/0307467 A1
(43) Pub. Date: Dec. 15, 2011

(54) DISTRIBUTED WEB CRAWLER ARCHITECTURE

(76) Inventor: Stephen Severance, San Francisco, CA (US)

(21) Appl. No.: 12/813,400

(22) Filed: Jun. 10, 2010

(51) Int. Cl. G06F 17/30; G06F 15/16

(52) U.S. Cl. 707/709; 709/245; 707/E17.032; 707/E17.108

(57) ABSTRACT

A distributed web crawler architecture is provided. An example system comprises a work items, a duplicate request detector, and a callback module. The work items monitor may be configured to detect a first work item from a first web crawler, the work item related to a URL. The duplicate request detector may be configured to determine that a second work item associated with the URL is present in a work queue, the work queue to provide work items to a fetcher, the second work item associated with a second web crawler The callback module may be configured to create a callback for the first web crawler, the callback indicating that a web page retrieved as a result of processing of the second work item is to be provided to the first web crawler, without queuing the first work item.

### TECHNICAL FIELD

This application relates to the technical fields of software and/or hardware technology and, in one example embodiment, to system and method to provide distributed web crawler architecture.

### BACKGROUND

A web crawler may be described as a computer program configured to obtain web documents for use by the search engines using information about a web document as provided by its address or Universal Resource Locator (URL), metadata, and other criteria found within the web document. A web crawler is run periodically to update previously stored data. A web crawler may be viewed as a crawler module (that generates work items—URLs that should be accessed) and a fetcher module (that obtains work items generated by the crawler module and retrieves web pages based on the URLs associated with the work items).

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a distributed web crawler architecture, in accordance with one example embodiment;

FIG. 2 is block diagram of a system to provide a work item service, in accordance with one example embodiment;

FIG. 3 is a flow chart of a method that reduces the number of instances where duplicate web pages are being fetched, in accordance with an example embodiment;

FIG. 4 is a diagrammatic representation of a bucket service architecture, in accordance with an example embodiment;

FIG. 5 is a flow chart of a method for grouping IP addresses into buckets, in accordance with an example embodiment; and

FIG. 6 is a diagrammatic representation of an example machine in the form of a computer system within which a set of instructions, for causing the machine to perform any one or more of the methodologies discussed herein, may be executed.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

A distributed crawl/fetch architecture is proposed for centralized management of multiple web crawlers, where work items received from web crawlers are processed by an intermediary module in a manner that helps avoid fetching the same web page twice when more than one work items are associated with the same URL. The crawlers in the distributed crawl/fetch architecture may be so-called directed crawlers, where each directed crawler is configured to target certain type of web pages, such as, e.g., only blog web pages or only web pages that may contain financial data. Each web crawler generates work items that may be represented by a URL of a web page. An intermediary module configured to receive work items from web crawlers and dispatch the received work items to one or more fetchers may be termed a work items service.

In one example embodiment, a work item service provided in a distributed crawl/fetch architecture may be configured to examine a work item (e.g., from crawler A) with respect to an associated URL and compare the URL to URLs that are present in one or more active work queues. If there is already a work item (e.g., a work item from crawler B) with that URL in any of the active work queues, a reference to the address the crawler web service for crawler A is created so that a web page fetched from the URL is provided not only to the crawler B, but also to the crawler A. Such reference may be termed a callback. The created callback is added to the list of addresses to be called when the requested web page associated with the URL is fetched.

A distributed crawl/fetch architecture may be enhanced by utilizing a service that groups domain names (and the associated Internet protocol (IP) addresses) in a manner that helps to avoid potentially overwhelming a web server with requests. When this service (termed a bucket service) is used in the context of distributed crawl/fetch architecture, the work item service maps each work item received from a web crawler to a particular bucket based on the URL included in the work item. In one embodiment, a bucket service may alleviate a problem of potential multiple requests for the same web server initiated by different fetchers at the same time. A situation where requests for the same web server are initiated by multiple fetchers at the same time may arise where two distinct domain names associated with multiple IP addresses include overlapping IP addresses. For example, consider a situation where the first site.com is associated with IP1 and IP2 and the second sight.com is associated with IP addresses IP3 and IP1. Two fetch requests, directed to first site.com and second sight.com respectively, may result in two simultaneous requests to the same web server. Such simultaneous requests (that may result in overwhelming of a web server) may be avoided by segmenting the domain/IP space into buckets based on overlapping IP addresses associated with distinct domain names.

In one embodiment, a work item (a URL) generated by one of the web crawlers is queued in a queue that is associated with the particular bucket that contains the IP address associated with the work item. A fetcher (or several fetchers) may be configured to poll the buckets for work items. The buckets, in turn, may be configured to release work items with a predetermined frequency, such that even if a queue contains requests associated with the same domain name, these requests would not be issued to a web server simultaneously. In one embodiment, different buckets may be configured with different throughput throttles, such that, e.g., a queue associated with one domain/IP bucket releases work items less frequently than a queue associated with another domain/IP bucket.

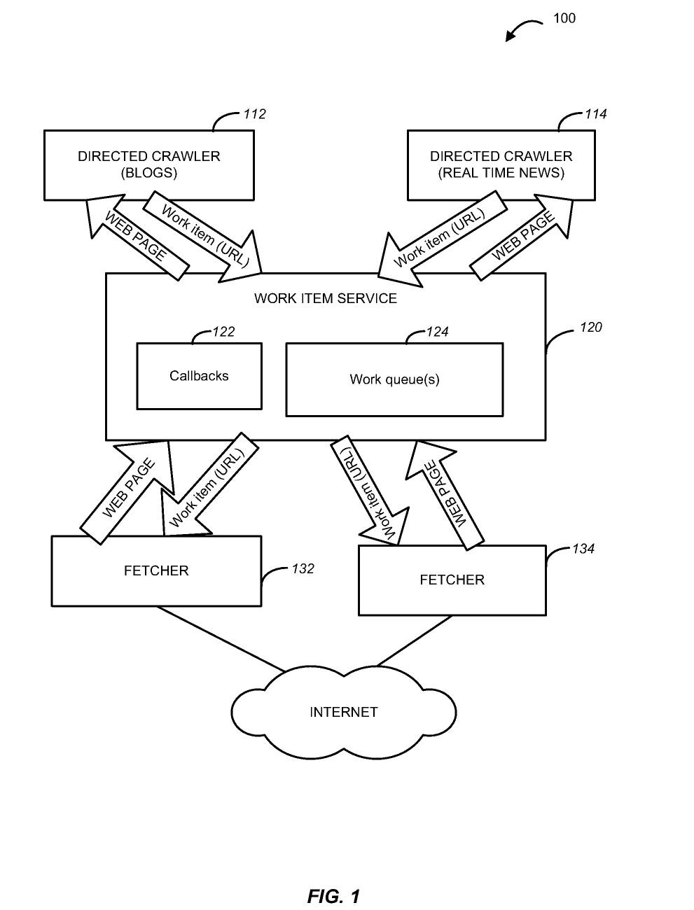

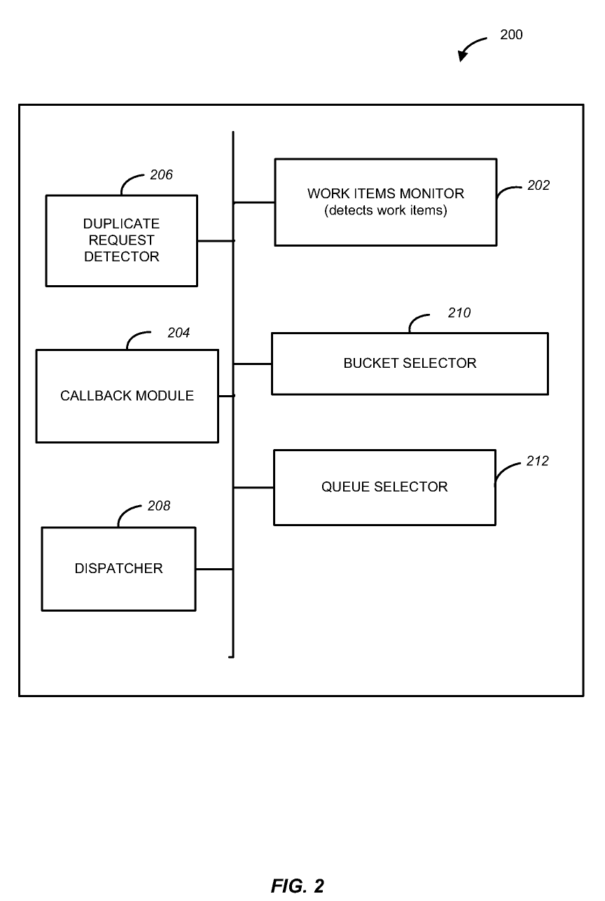

FIG. 1 is a diagrammatic representation of a distributed web crawler architecture 100, in accordance with one example embodiment. As shown in FIG. 1, the architecture 100 may include a number of web crawlers (such as a directed crawler 112 and a directed crawler 122) that generate work items in the form of URLs and provide the work items to one or more fetchers (e.g., a fetcher 132 and a fetcher 134) via a work item service 120. The work item service queues the work items (the URLs) received from the crawlers in one or more work queues 124. Each of the work queues 124 releases work items to the fetchers 132 and 134 periodically. For example, once the fetcher 132 obtains a work item from a queue of the work items service 120, it fetches a web page from a URL associated with the work item and provides it to the work item service 120. The work item service 120, in turn, provides the fetched web page to all web crawlers identified in a callbacks list 122. The callbacks list 122, in one embodiment is a list URLs, where each URL is associated with addresses of those web crawlers that should be receiving the web page corresponding to the URL. It will be noted that, while two web crawlers and two fetchers are shown in FIG. 1, a distributed web crawler architecture may comprise any number of web crawlers and any number of fetchers. Various modules that may be included in the work item service 120 may be described with reference to FIG. 2.

FIG. 2 is block diagram of a system 200 to provide a work item service, in accordance with one example embodiment. As shown in FIG. 2, the system 200 comprises a work items monitor 202, a callback module 204, and a duplicate request detector 206. The work items monitor 202 may be configured to detect work items received from one or more web crawlers. As explained above, the web crawlers may be directed web crawlers where each of the directed web crawlers is configured to generated work items for obtaining web pages containing a particular type of information. For example, one directed crawler may be configured to generated work items associated with real time news web pages, while another web crawler may be configured to generate work items associated with web pages containing financial date. A work item may be provided to the work items monitor 202 in the form of a URL. When a work item is detected by the work items monitor 202, the work item is queued in one of work queues maintained by the system 200. The callback module 204 may be configured to create a callback indicating that a web page retrieved in response to the processing of the work item is to be provided to a particular web crawler. A callback may be in the form of a URL/address pair, where the URL represents the work item and the address is the address of a web crawler that should be receiving the web page retrieved using the URL.

The duplicate request detector 206 may be configured to determine whether a work item associated with the same web page as the newly-received work item has already been queued in a work queue maintained by the system 200. In one embodiment, the duplicate request detector 206 determines whether a URL representing the newly-received work item is present in a work queue. The presence of a URL representing a work item in a work queue indicates that a web page associated with the URL will be retrieved by a fetcher and provided to the system 200. When the duplicate request detector 206 determines that a work item associated with the same web page as the newly-received work item has already been queued in a work queue maintained by the system 200, the newly-received work item is not queued thereby preventing the second fetching of the same web page. Instead, the callback module 204 creates a callback indicating that a web page retrieved in response to the already-queued work item is to be provided to the web crawler that generated this newly-received work item. Thus, when multiple web crawlers generate work items that require retrieving of the same web page, the web page is fetched only once, and provided each of the crawlers that generated work items requesting that web page.

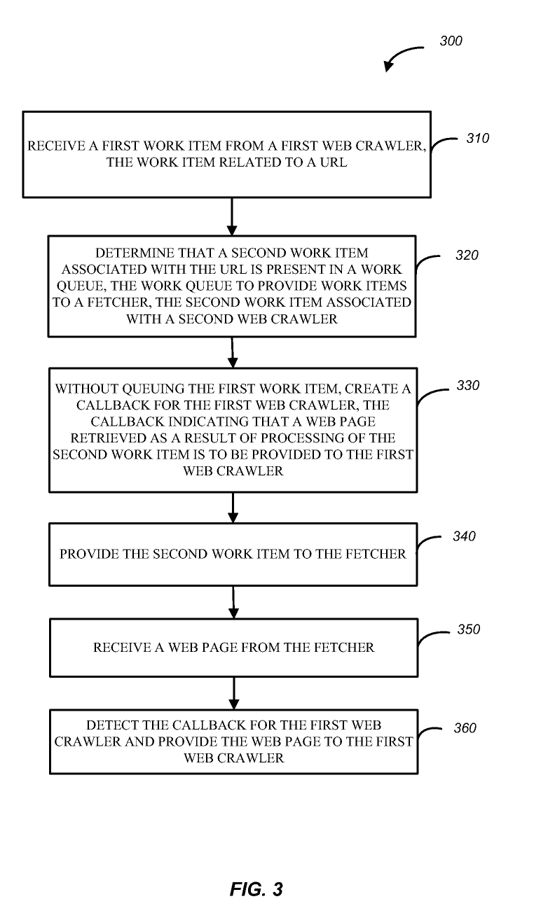

Also shown in FIG. 2 is a dispatcher 208. The dispatcher 208 may be configured to provide work items to a fetcher, receive web pages retrieved by the fetcher, detect one or more callbacks associated with a retrieved web page, and execute the one or more callbacks such that each retrieved page is provided to those web crawlers that requested them. An example method that reduces the number of instances where duplicate web pages are being fetched can be described with reference to FIG. 3.

FIG. 3 is a flow chart of a method 300 to generate a callback indicating that a web page is to be provided to a web crawler without issuing an additional fetch request, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system work items service 120 of FIG. 1 and, specifically, at the system 200 shown in FIG. 2.

As shown in FIG. 3, the method 300 commences at operation 310, when the system 200 of FIG. 2 receives a first work item from a first web crawler. The work item may be in the form of a URL associated with a desired web page. At operation 320, the duplicate request detector 206 of FIG. 2 determines that another work item, that is associated with the same URL as the received work item, is already present in a work queue. The other work item that is already present in a work queue may be associated with a second web crawler. For example, a blogs web crawler and a real time news web crawler may generate work items that would result in retrieving of the same web page. As mentioned above, the system 200 for providing a work items service may be configured to maintain one or more work queues that periodically release work items to one or more fetchers. At operation 330, in response to the determining performed at operation 320, the callback module 202 of FIG. 2 creates a callback for the first web crawler, the callback indicating that a web page retrieved as a result of processing of the other work item (the second or already-queued work item) is to be provided to the first web crawler. The first work item is not placed in a work queue so as to avoid fetching the same web page twice.

At operation 340, the already-queued work item is provided to a fetcher and the fetcher retrieves the associated web page. The dispatcher 208 received the retrieved web page at operation 350, detects the callback for the first web crawler as provides the web page to the first web crawler at operation 360. Thus, while the second (or already-queued) work item was generated by the second web crawler, a web page fetched as the result of that work item is provided not only to the second web crawler but also to the first web crawler, thus avoiding an additional fetching operation.

Returning to FIG. 2, in one embodiment, the system 200 to provide a work items service includes a bucket selector 210 and a queue selector 212. As mentioned above, a distributed crawl/fetch architecture may be enhanced by utilizing a bucket service that groups domain names and the associated IP addresses in a manner that helps to avoid potentially overwhelming a web server. In one embodiment, the bucket selector 210 and the queue selector 212 may be implemented as part of a bucket service. The bucket selector 210 may be utilized to assign a the IP address(es) associated of a URL based on its domain name. For example, the bucket selector 210 may be configured to access a first URL, determine the domain name, determine a set of IP addresses associated with the domain name, and place the domain name and the associated set of IP addresses into a certain bucket. The bucket selector 210 may then access another URL, determine the domain name of the URL and a second set of IP addresses associated with the second domain name. If any one of the IP addresses associated with the second domain name is the same as any of the IP addresses that are already associated with the first bucket, the IP addresses associated with the second domain name are placed into the first bucket. If, however, no one of the IP addresses associated with the second URL is the same as any of the IP addresses that are already associated with the first bucket, the IP addresses associated with the second domain name are placed into a new bucket. In one embodiment, every work queue maintained by the work items service is associated with a particular bucket. Conversely, every bucket maintained by the bucket service is associate with its own queue for queuing work items associated with IP addresses contained in that bucket. Work items received from web crawlers may be placed into different queues according to their associated IP address(es). The selection of a queue is performed by the queue selector 212.

In one embodiment, the queue selector 212 may be configured to receive a work item associated with a URL, determine an IP address based on the URL, determine a bucket from a plurality of buckets associated with the IP address, and queue the work item in a work queue associated with the determined bucket.

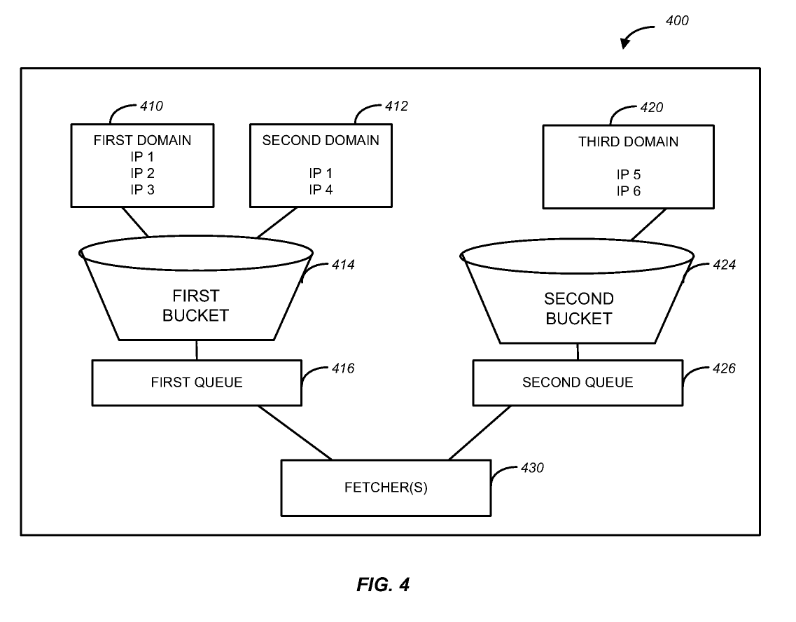

FIG. 4 is a diagrammatic representation of a bucket service architecture 400, in accordance with an example embodiment. As shown in FIG. 4, a first domain 410 is associated with IP addresses IP1, IP2, and IP3. A second domain 412 is associated with IP addresses IP1 and IP4. IP1, thus, is associated with both domains 410 and 412. In order to alleviate the stress on the web server that processes requests to the first domain 410 and the second domain 412, the associated domain names and their respective IP addresses are assigned to a first bucket 414. The first bucket 414 is associated with a first queue 416. A work item associated with an IP address that is present in the first bucket 414 is queued in the first queue 416.

Also shown in FIG. 4 is a third domain 420 that is associated with IP addresses IP5 and IP6. If neither IP5 nor IP6 is present in the first bucket 414, the a third domain 420 and its associated IP addresses IP5 and IP6 are assigned to a second bucket 424. The second bucket 424 is associated with a second queue 426. A work item associated with an IP address that is present in the second bucket 424 is queued in the second queue 426. Work items stored in the first queue 426 and the second queue 426 are released to one or more fetchers 430 with a predetermined frequency, such that even if a queue contains requests associated with the same domain name, these requests would not be issued to a web server simultaneously. As mentioned above, in one embodiment, different buckets may be configured with different throughput throttles, such that, e.g., a queue associated with one domain/IP bucket releases work items less frequently than a queue associated with another domain/IP bucket.

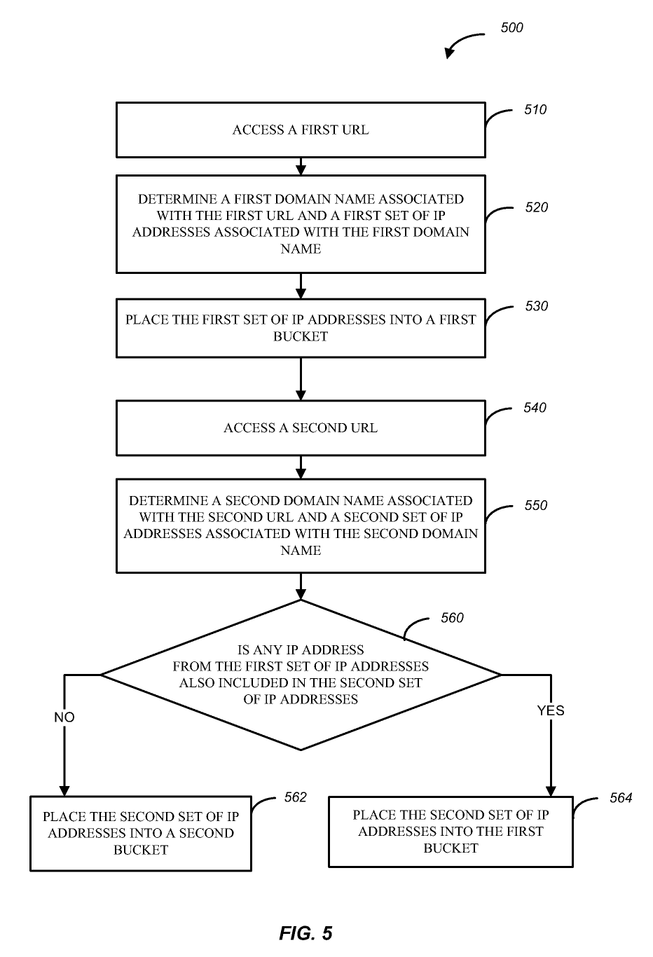

FIG. 5 is a flow chart of a method 500 for grouping IP addresses into buckets, in accordance with an example embodiment. The method 500 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system work items service 120 of FIG. 1 and, specifically, at the system 200 shown in FIG. 2.

As shown in FIG. 5, the method 500 commences at operation 510, where the bucket selector 210 of FIG. 2 accesses a first URL that represents a work item created by one of web crawlers. At operation 520, the bucket selector 210 determines, from the first URL, a first domain name and a first set of IP addresses associated with the first domain name. At operation 530, the first set of IP addresses is placed in a first bucket. The bucket selector 210 accesses a second URL that represents another work item created by one of web crawlers at operation 540. At operation 550, the bucket selector 210 determines, from the second URL, a second domain name and a second set of IP addresses associated with the second domain name. At operation 560, the bucket selector 210 determines whether any IP address from the first set of the IP addresses is also present in the second set of the IP addresses. If so, the second set of the IP addresses is placed in a second bucket (operation 562). Otherwise, the second set of the IP addresses is placed in the first bucket (operation 564).

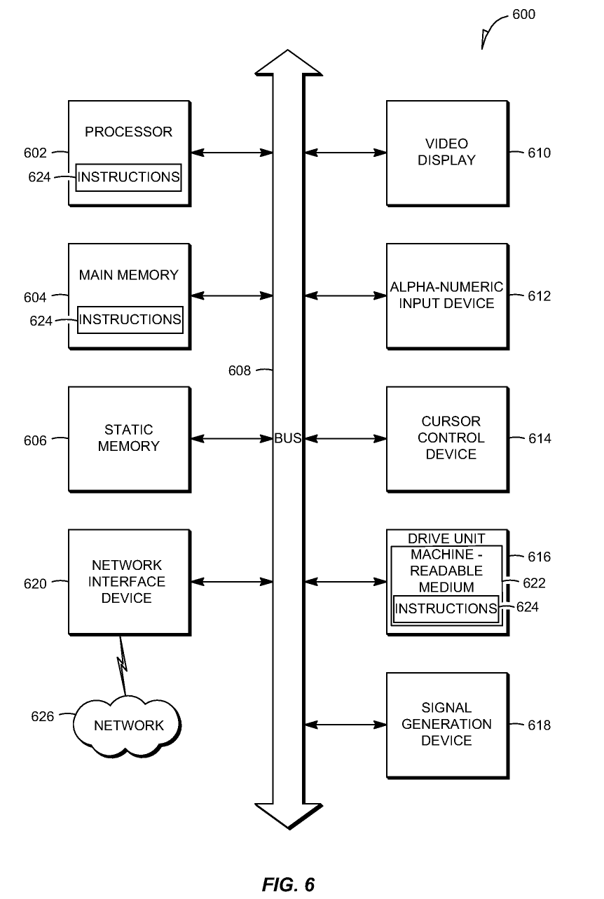

FIG. 6 shows a diagrammatic representation of a machine in the example form of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, a distributed web crawler architecture has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

What is claimed is:

1. A method comprising:
receiving a first work item from a first web crawler, the work item related to a Universal Resource Locator (URL);
determine that a second work item associated with the URL is present in a work queue, the work queue to provide work items to a fetcher, the second work item associated with a second web crawler; and
without queuing the first work item, create a callback for the first web crawler, the callback indicating that a web page retrieved as a result of processing of the second work item is to be provided to the first web crawler.

2. The method of claim 1, wherein the callback for the first web crawler comprises an address of the first web crawler.

3. The method of claim 1, comprising:
providing the second work item to the fetcher,
receiving a web page from the fetcher;
detecting the callback for the first web crawler; and
providing the web page to the first web crawler.

4. The method of claim 1, comprising:
receiving a third work item associated with a second URL;
determining an IP address based on the second URL;
determining a bucket from a plurality of buckets associated with the Internet protocol (IP) address; and
queuing the third work item in a work queue from a plurality of work queues, the work queue associated with the determined bucket.

5. The method of claim 4, wherein any IP address associated with a bucket from the plurality of buckets is associated with a single bucket from the plurality of buckets.

6. The method of claim 1, comprising:
accessing a first URL;
determining a first domain name associated with the first URL;
determining a first set of IP addresses associated with the first domain name;
placing the first set of IP addresses into a first bucket;
accessing a second URL;
determining a second domain name associated with the second URL;
determining a second set of IP addresses associated with the second domain name;
determining that an IP address from the first set of IP addresses is also included in the second set of IP addresses; and
in response to the determining that an IP address from the first set of IP addresses is also included in the second set of IP addresses, placing the second set of IP addresses into the first bucket.

7. The method of claim 1, comprising:
accessing a first URL;
determining a first domain name associated with the first URL;
determining a first set of IP addresses associated with the first domain name;
placing the first set of IP addresses into a first bucket;
accessing a second URL;
determining a second domain name associated with the second URL;
determining a second set of IP addresses associated with the second domain name; and
determining that no IP address from the first set of IP addresses is included in the second set of IP addresses;
in response to the determining that no IP address from the first set of IP addresses is included in the second set of IP addresses, placing the second set of IP addresses into a second bucket.

8. The method of claim 1, wherein the first web crawler and the second web crawler are provided by a distributed computer system.

9. The method of claim 1, wherein the first web crawler and the second web crawler are provided at a single server computer.

10. The method of claim 1, where in a fetcher is from a plurality of fetchers associated with a distributed web crawler system.

11. A computer-implemented system comprising:
a work items monitor to detect a first work item from a first web crawler, the work item related to a URL;
a duplicate request detector to determine that a second work item associated with the URL is present in a work queue, the work queue to provide work items to a fetcher, the second work item associated with a second web crawler; and
a callback module to create a callback for the first web crawler, the callback indicating that a web page retrieved as a result of processing of the second work item is to be provided to the first web crawler, without queuing the first work item.

12. The system of claim 11, wherein the callback for the first web crawler comprises an address of the first web crawler.

13. The system of claim 11, comprising a dispatcher to:
provide the second work item to the fetcher,
receive a web page from the fetcher;
detect the callback for the first web crawler; and
provide the web page to the first web crawler.

14. The system of claim 11, comprising a queue selector to:
receive a third work item associated with a second URL;
determine an IP address based on the second URL;
determine a bucket from a plurality of buckets associated with the IP address; and
queue the third work item in a work queue from a plurality of work queues, the work queue associated with the determined bucket.

15. The system of claim 14, wherein any IP address associated with a bucket from the plurality of buckets is associated with a single bucket from the plurality of buckets.

16. The system of claim 11, comprising a bucket selector to:
access a first URL;
determine a first domain name associated with the first URL;
determine a first set of IP addresses associated with the first domain name;
place the first set of IP addresses into a first bucket;
access a second URL;
determine a second domain name associated with the second URL;
determine a second set of IP addresses associated with the second domain name;
determine that an IP address from the first set of IP addresses is also included in the second set of IP addresses; and
in response to the determining that an IP address from the first set of IP addresses is also included in the second set of IP addresses, place the second set of IP addresses into the first bucket.

17. The system of claim 15, wherein the bucket selector is to:
access a first URL;
determine a first domain name associated with the first URL;
determine a first set of IP addresses associated with the first domain name;
place the first set of IP addresses into a first bucket;
access a second URL;
determine a second domain name associated with the second URL;
determine a second set of IP addresses associated with the second domain name;
determine that no IP address from the first set of IP addresses is included in the second set of IP addresses; and
in response to the determining that no IP address from the first set of IP addresses is included in the second set of IP addresses, place the second set of IP addresses into a second bucket.

18. The system of claim 11, wherein the first web crawler and the second web crawler are provided by a distributed computer system.

19. The system of claim 11, where in a fetcher is from a plurality of fetchers associated with a distributed web crawler system.

20. A machine-readable storage medium having instruction data to cause a machine to:
detect a first work item from a first web crawler, the work item related to a URL;
determine that a second work item associated with the URL is present in a work queue, the work queue to provide work items to a fetcher, the second work item associated with a second web crawler; and
create a callback for the first web crawler, the callback indicating that a web page retrieved as a result of processing of the second work item is to be provided to the first web crawler, without queuing the first work item.
